(19) United States
(12) Patent Application Publication
(10) Pub. No.: US 2011/0085877 A1
(43) Pub. Date: Apr. 14, 2011

(54) DOWNHOLE TOOL

(75) Inventor: Andrew J. Osborne, JR., Dallas, TX (US)

(73) Assignee: ATLAS COPCO SECOROC LLC., Grand Prairie, TX (US)

(21) Appl. No.: 12/902,989

(22) Filed: Oct. 12, 2010

Related U.S. Application Data
(60) Provisional application No. 61/250,678, filed on Oct. 12, 2009.

(51) Int. Cl. F16B 19/05; B23P 11/00; B23P 17/00

(52) U.S. Cl. 411/500; 29/525.01; 29/525.14

(57) ABSTRACT

A downhole tool includes a cutter rotatably mounted to a journal. The journal is fastened to a downhole tool frame with a fastener. The fastener is engaged by an insert and retainer so it is restricted from rotating. The insert extends over a head of the fastener, and the retainer extends over the insert.

### CROSS-REFERENCE TO RELATED APPLICATIONS

This application claims priority to U.S. Provisional Application No. 61/250,678, filed on Oct. 12, 2009 by the same inventor, the contents of which are incorporated by reference as though fully set forth herein.

### BACKGROUND OF THE INVENTION

1. Field of the Invention

This invention relates generally to a tool for boring through a formation.

2. Description of the Related Art

There are many different types of tools for boring through a formation. One type of tool is a downhole tool, which includes a downhole tool frame that can be coupled to a drill string. These types of downhole tools can carry one or more cutters, which are fastened to the outer periphery of the downhole tool frame. The cutter(s) are typically rotatably mounted to a corresponding journal, and the journal is coupled to the tool frame using bolts. However, the bolt can be damaged in response to the extreme loads that the downhole tool experiences when boring through the formation. The journal can be decoupled from the tool frame in response to its corresponding bolt being damaged, and can fall down the borehole. It is typically expensive and time consuming to remove a cutter and journal from a borehole. Hence, it is desirable to provide a better way to fasten a journal to a tool frame of a downhole tool.

### BRIEF SUMMARY OF THE INVENTION

The present invention is directed to downhole tools. The novel features of the invention are set forth with particularity in the appended claims. The invention will be best understood from the following description when read in conjunction with the accompanying drawings.

### BRIEF DESCRIPTION OF THE DRAWINGS

FIG. 1 is a perspective view of downhole tool frames.

FIG. 2 is a perspective view of a cutter rotatably mounted to a journal.

FIG. 3 is an exploded perspective view of a cutter assembly.

FIG. 4 is a perspective view of fasteners and washers of the cutter assembly of FIG. 3.

FIG. 5 is a perspective view of bolt retainers of the cutter assembly of FIG. 3.

FIGS. 6a and 6b are perspective views of a partially assembled downhole tool, wherein the fasteners and washers of FIG. 4 are being fastened to the journal of FIG. 2 and the downhole tool frames of FIG. 1.

FIGS. 7a and 7b are perspective views of the partially assembled downhole tool of FIGS. 6a and 6b, wherein inserts are being engaged with the fasteners.

FIG. 7c is a top view of the inserts engaged with the fasteners of FIGS. 6a and 6b.

FIGS. 8a and 8b are perspective views of the partially assembled downhole tool of FIGS. 6a and 6b, wherein the bolt retainers of FIG. 5 are being engaged with the downhole tool frames.

FIG. 8c is a cut-away side view of the downhole tool of FIGS. 8a and 8b taken along a cut-line 8c-8c of FIG. 8b, wherein the fasteners are flush with the insert and retainers.

FIG. 8d is a cut-away side view of the insert of FIG. 8c.

FIG. 8e is a cut-away side view of the retainer of FIG. 8c.

FIG. 8f is a cut-away side view of the downhole tool of FIGS. 8a and 8b taken along cut-line 8c-8c of FIG. 8b, wherein the fasteners terminate below the insert and retainer.

FIG. 8g is a cut-away side view of the downhole tool of FIGS. 8a and 8b taken along cut-line 8c-8c of FIG. 8b, wherein the fasteners terminate above the insert and retainer.

FIG. 8h is a cut-away side view of the downhole tool of FIGS. 8a and 8b taken along cut-line 8c-8c of FIG. 8b, wherein the fasteners and inserts terminate below the retainer.

FIG. 8i is a cut-away side view of the downhole tool of FIGS. 8a and 8b taken along cut-line 8c-8c of FIG. 8b, wherein the fasteners and inserts terminate above the retainer.

FIG. 8j is a close-up perspective view of the downhole tool of FIGS. 8a and 8b, wherein the bolt retainers are welded to the downhole tool frames and corresponding inserts.

FIG. 9 is a perspective view of the downhole tool of FIG. 8d being carried by a drill string.

### DETAILED DESCRIPTION OF THE INVENTION

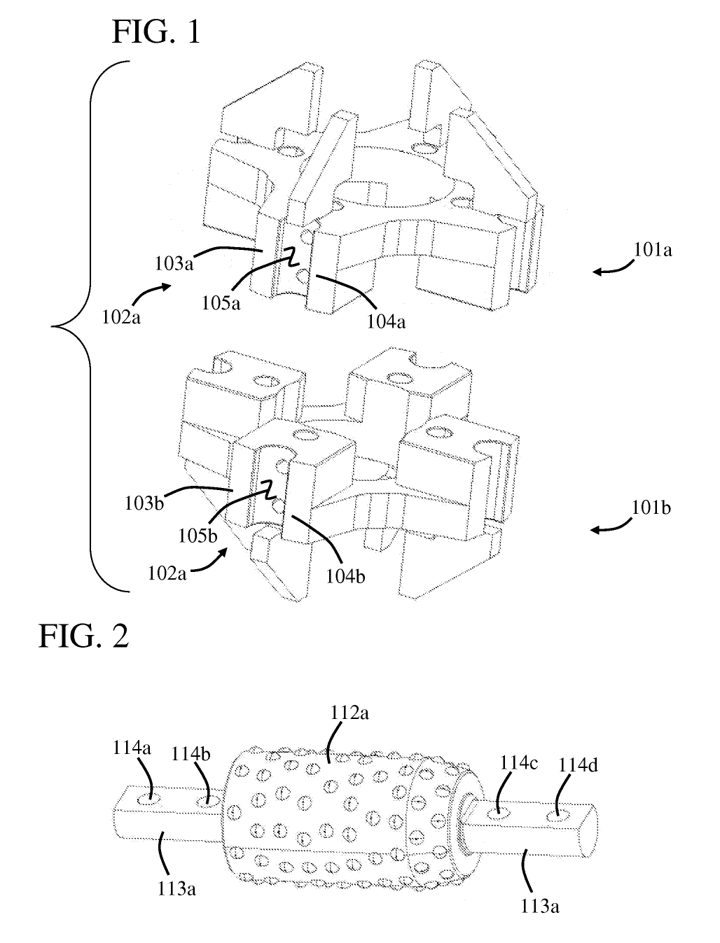

FIG. 1 is a perspective view of downhole tool frames 101a and 101b. In this embodiment, downhole tool frames 101a and 101b include saddles 102a and 102b, respectively. Saddle 102a includes a journal channel 105a which extends between opposed reamer surfaces 103a and 104a. Further, saddle 102b includes a journal channel 105b which extends between opposed reamer surfaces 103b and 104b. Journal saddles 105a and 105b are sized and shaped to receive a journal, one of which will be discussed in more detail presently.

FIG. 2 is a perspective view of a cutter 112a rotatably mounted to a journal 113a. In this embodiment, cutter 112a includes opposed journal openings through which journal 113a extends. Journal 113a includes fastener openings 114a and 114b, which are positioned on one side of cutter 112a, and fastener openings 114c and 114d, which are positioned on an opposed side of cutter 112a. Cutter 112a and journal 113a are included in a cutter assembly, one of which will be discussed in more detail presently.

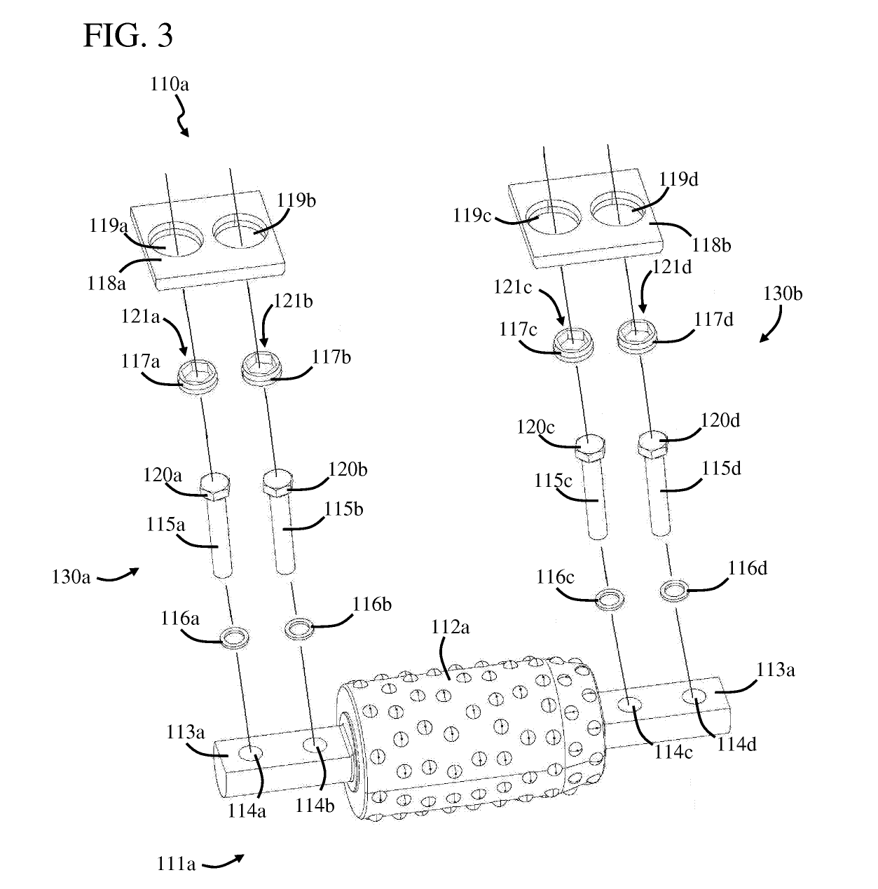

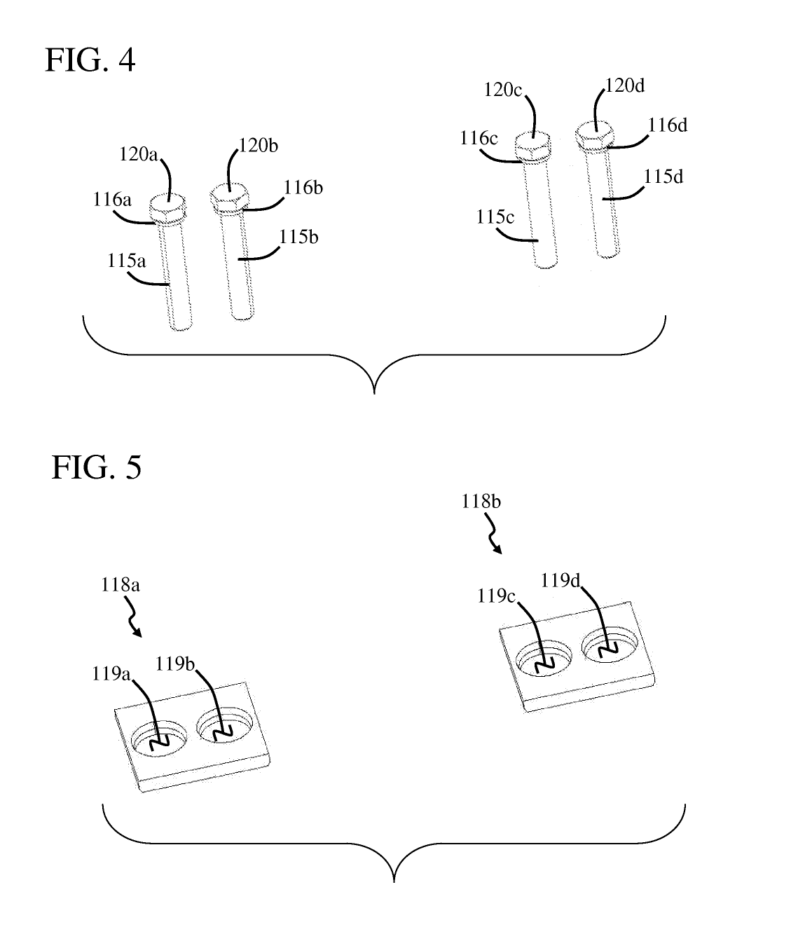

FIG. 3 is an exploded perspective view of a cutter assembly 110a. In this embodiment, cutter assembly 110a includes cutter 112a rotatably mounted to journal 113a, as described in more detail above with FIG. 2. Cutter assembly 110a includes fasteners 115a, 115b, 115c and 115d and washers 116a, 116b, 116c and 116d. Fasteners 115a, 115b, 115c and 115d are used to couple journal 113a to downhole tool frames 101a and 101b (FIG. 1), as discussed in more detail below. In this way, journal 113a is coupled to downhole tool frames 101a and 101b. Fasteners 115a, 115b, 115c and 115d include fastener heads 120a, 120b, 120c and 120d. Fastener heads 120a, 120b, 120c and 120d can be of many different types. For illustrative purposes, fastener heads 120a, 120b, 120c and 120d are embodied as being hex heads having six sides. Washers 116a, 116b, 116c and 116d are received by fasteners 115a, 115b, 115c and 115d, respectively, as shown in FIG. 4, so they engage corresponding fastener heads 120a, 120b, 120c and 120d.

In this embodiment, cutter assembly 110a includes inserts 117a, 117b, 117c and 117d. Inserts 117a, 117b, 117c and 117d include fastener head openings 121a, 121b, 121c and 121d which are sized and shaped to receive corresponding fastener heads. In this embodiment, fastener head openings 121a, 121b, 121c and 121d are sized and shaped to receive fastener heads 120a, 120b, 120c and 120d, respectively. Hence, fastener head openings 121a, 121b, 121c and 121d have six sides which correspond to the six sides of fastener heads 120a, 120b, 120c and 120d, respectively. In this way, inserts 117a, 117b, 117c and 117d are hex head inserts and fastener head openings 121a, 121b, 121c and 121d are hex head openings.

In this embodiment, cutter assembly 110a includes retainers 118a and 118b, as shown in a perspective view in FIG. 5. Retainer 118a includes insert openings 119a and 119b, and retainer 118b includes insert openings 119c and 119d. Insert openings 119a, 119b, 119c and 119d are sized and shaped to receive corresponding inserts. In this embodiment, insert openings 119a, 119b, 119c and 119d are sized and shaped to receive inserts 117a, 117b, 117c and 117d, respectively. As discussed in more detail below, insert openings 119a and 119b are sized and shaped to receive inserts 117a and 117b, respectively, so that inserts 117a and 117b are held to corresponding fastener heads 120a and 120b, as well as to journal 113a. In this embodiment, retainer 118a engages inserts 117a and 117b, and inserts 117a and 117b engage fastener heads 120a and 120b, respectively. Further, insert openings 119c and 119d are sized and shaped to receive inserts 117c and 117d, respectively, so that inserts 117c and 117d are held to corresponding fastener heads 120c and 120d, as well as to journal 113a. In this embodiment, retainer 118b engages inserts 117c and 117d, and inserts 117c and 117d engage fastener heads 120c and 120d, respectively.

It should be noted that, in this embodiment, a locking fastener assembly 130a includes inserts 117a and 117b, retainer 118a, fasteners 115a and 115b and washers 116a and 116b. Further, in this embodiment, a locking fastener assembly 130b includes inserts 117c and 117d, retainer 118b, fasteners 115c and 115d and washers 116c and 116d. Locking fastener assemblies 130a and 130b fasten and lock journal 113a to downhole tool frames 101a and 101b, respectively, as will be discussed in more detail presently.

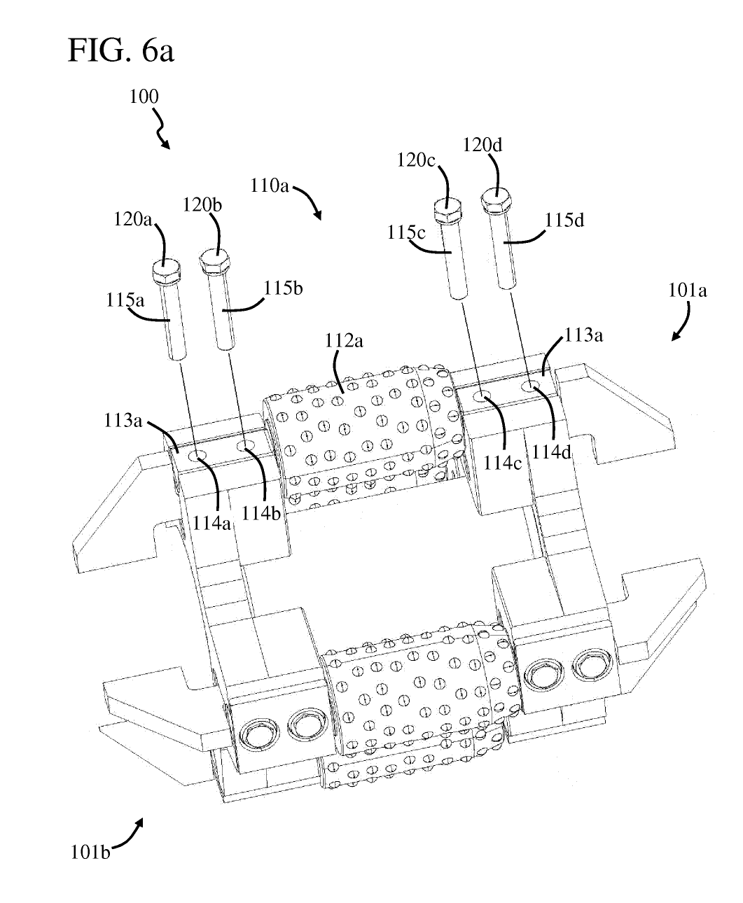

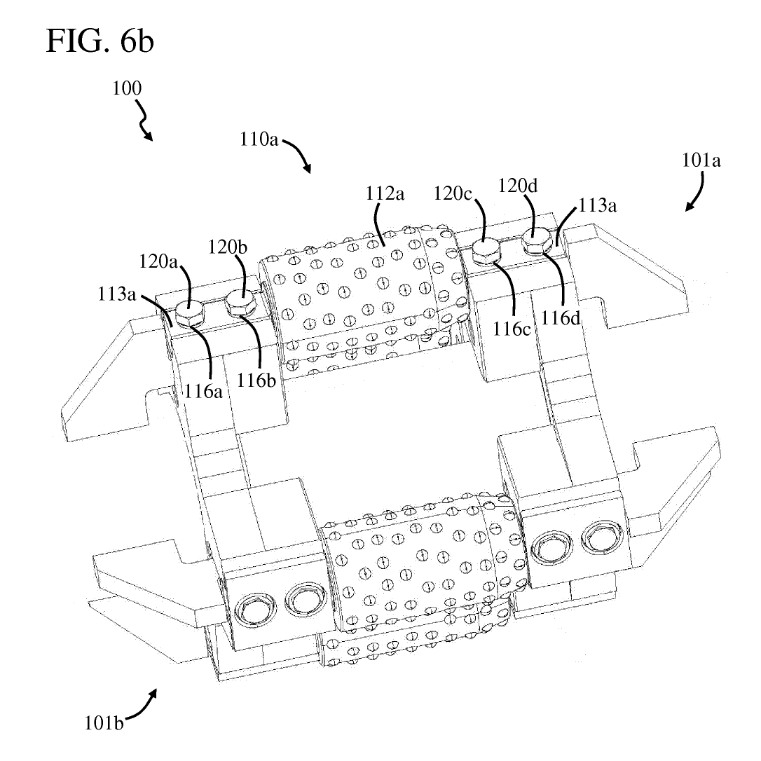

FIGS. 6a and 6b are perspective views of a partially assembled downhole tool 100. In this embodiment, downhole tool 100 includes downhole tool frames 101a and 101b, which are shown in FIG. 1. In this embodiment, cutter 112a is rotatably mounted to journal 113a, as described in more detail above with FIG. 2. Further, journal 113a is positioned so that it extends through journal channels 105a and 105b of corresponding downhole tool frames 101a and 101b. In this way, journal 113a is coupled to downhole tool frames 101a and 101b.

In this embodiment, washers 116a, 116b, 116c and 116d are received by fasteners 115a, 115b, 115c and 115d, respectively, as described in more detail above with FIG. 4. Fasteners 115a and 115b extend through fastener openings 114a and 114b, respectively, so that washers 116a and 116b engage journal 113a, and journal 113a is fastened to downhole tool frame 101a. Further, fasteners 115c and 115d extend through fastener openings 114c and 114d, respectively, so that washers 116c and 116d engage journal 113a, and journal 113a is fastened to downhole tool frame 101b. Journal 113a is shown fastened to downhole tool frames 101a and 101b in FIG. 6b. It should be noted that fastener heads 120a and 120b extend away from reamer surfaces 103b and 104b (FIG. 1), and fastener heads 120c and 120d extend away from reamer surfaces 103a and 104a.

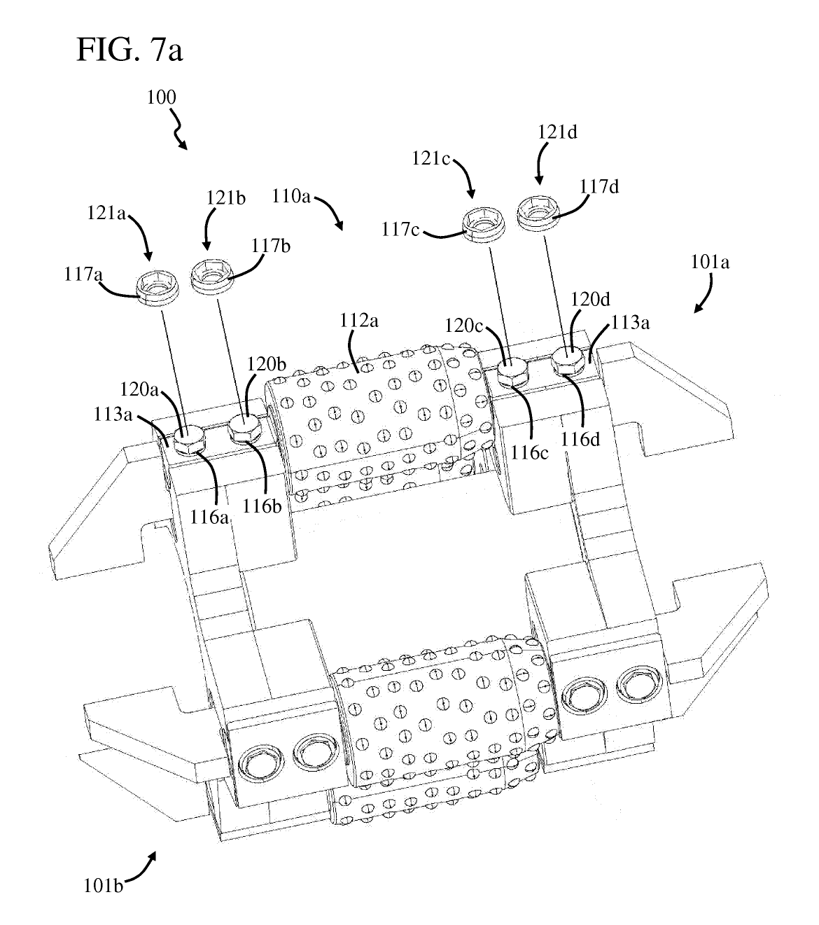

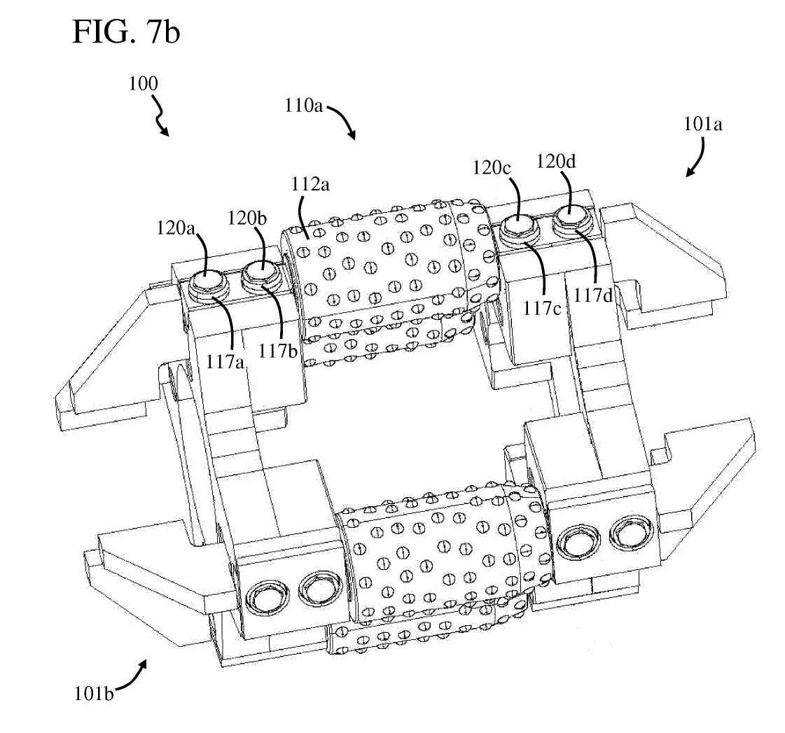

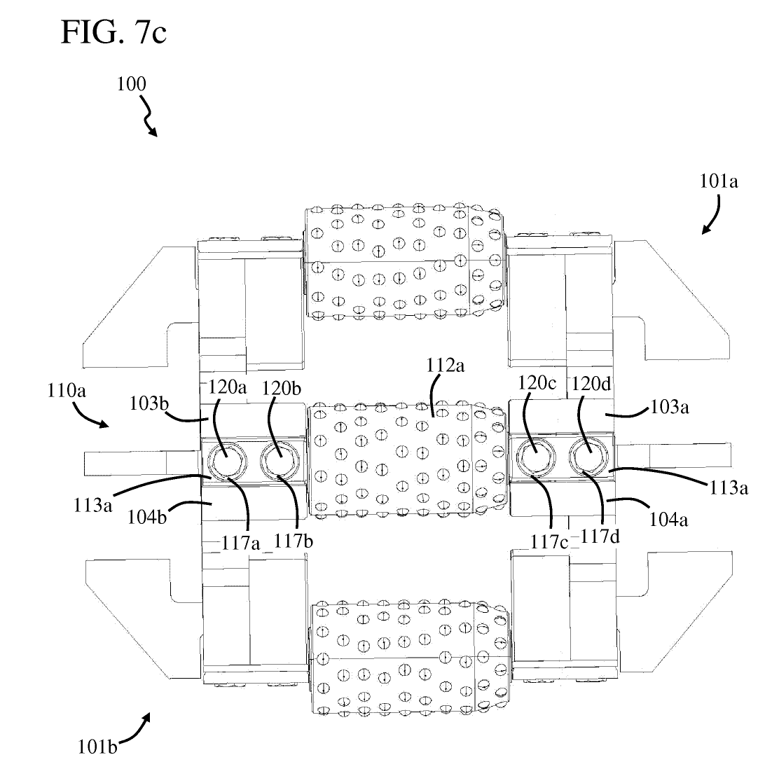

FIGS. 7a and 7b are perspective views of partially assembled downhole tool 100. In FIG. 7a, inserts 117a and 117b are positioned so that fastener heads 120a and 120b extend through fastener head openings 121a and 121b, respectively. Further, inserts 117c and 117d are positioned so that fastener heads 120c and 120d extend through fastener head openings 121c and 121d. As discussed in more detail above, fastener head openings 121a, 121b, 121c and 121d are sized and shaped to receive fastener heads 120a, 120b, 120c and 120d, respectively, as shown in FIG. 7b. FIG. 7c is a top view of inserts 117a, 117b, 117c and 117d engaged with fastener heads 120a, 120b, 120c and 120d, respectively. It should be noted that inserts 117a and 117b extend away from reamer surfaces 103b and 104b, and inserts 117c and 117d extend away from reamer surfaces 103a and 104a.

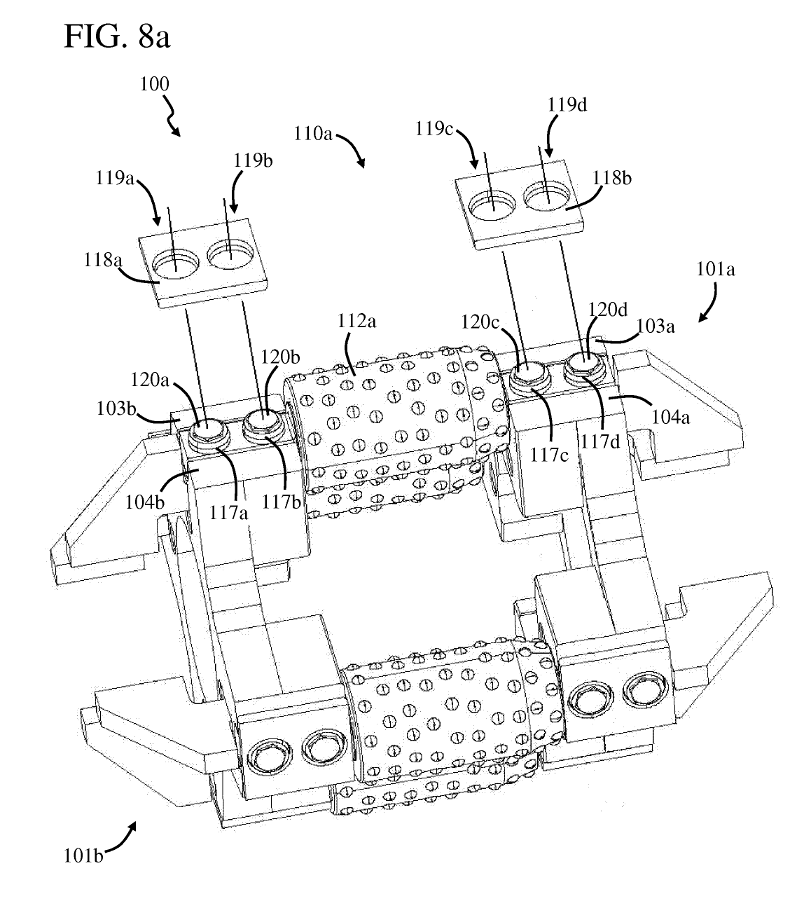

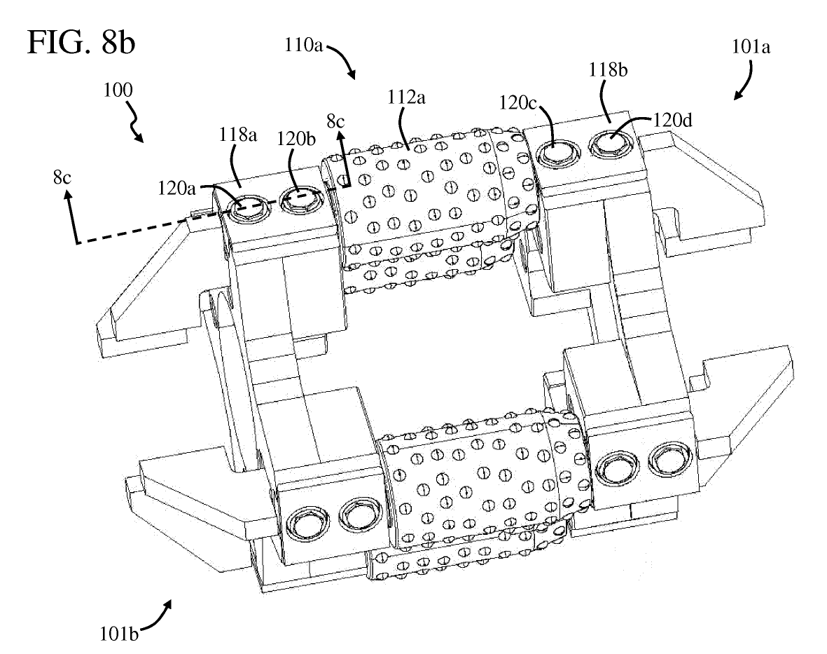

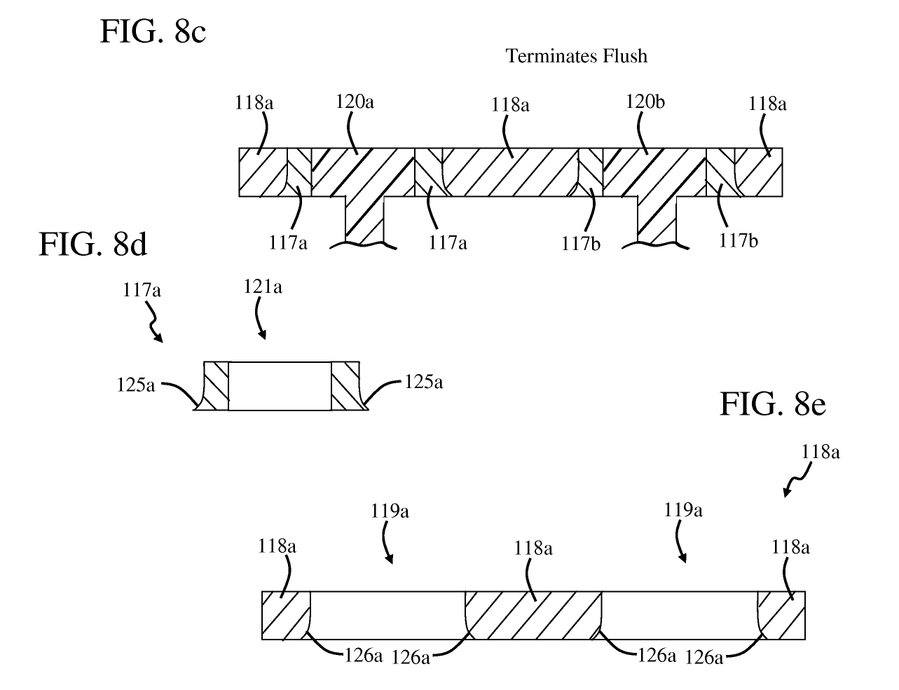

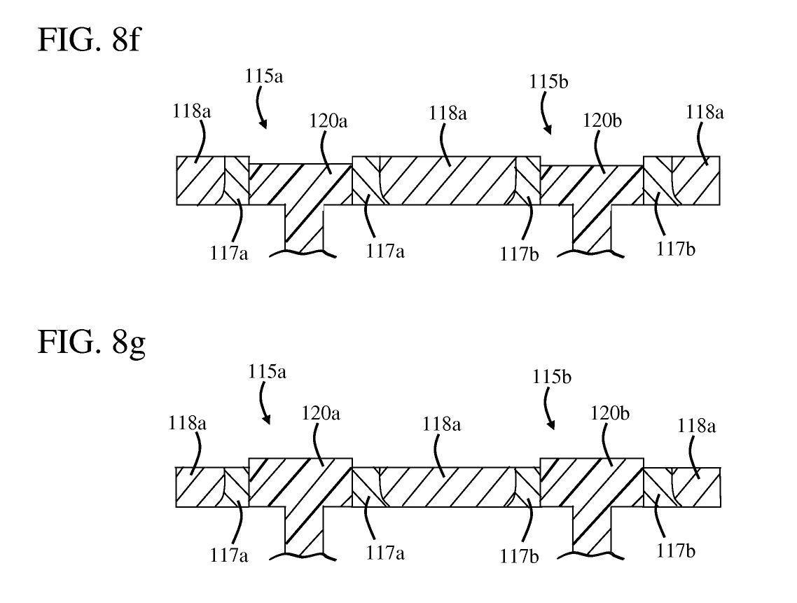

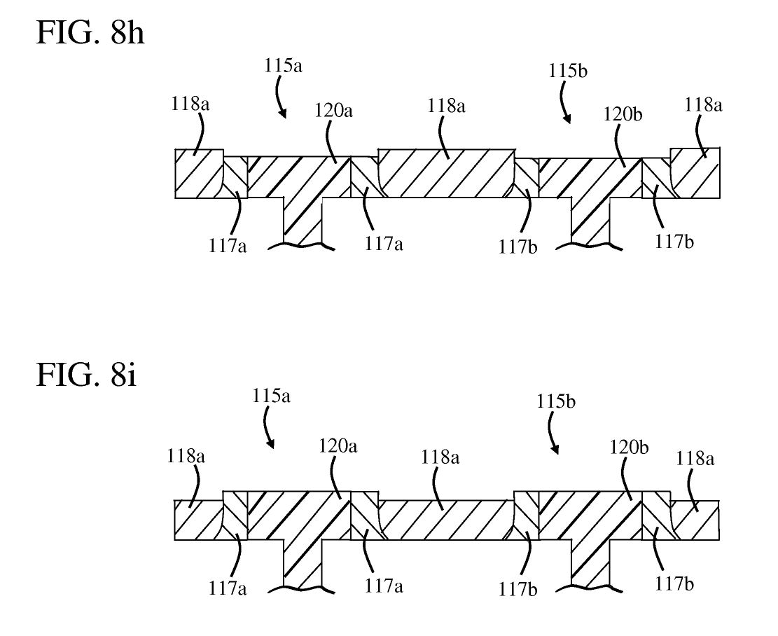

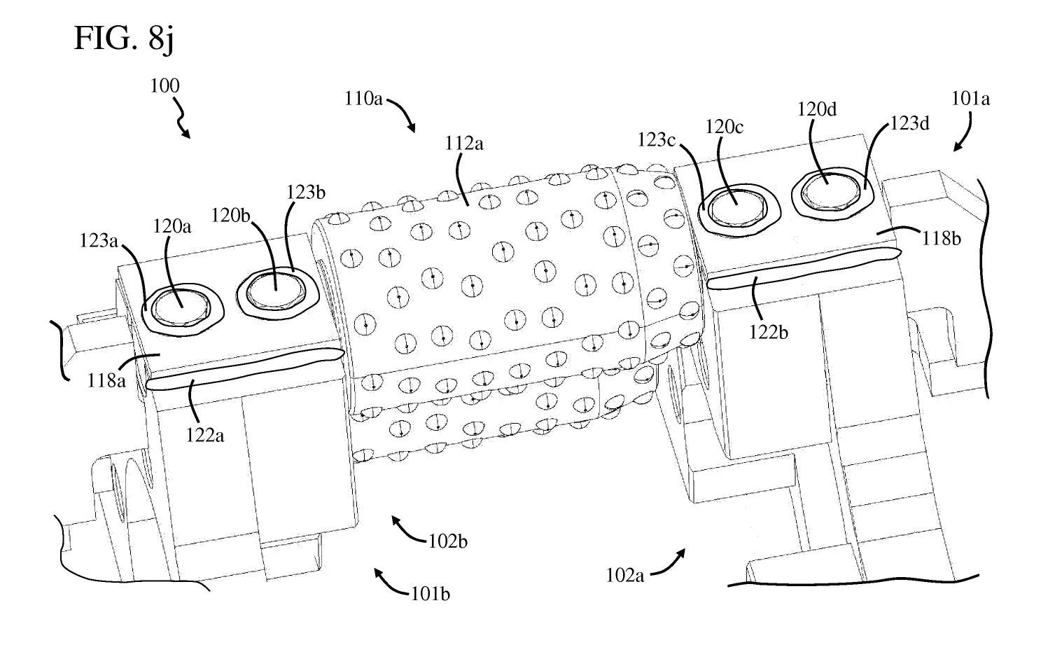

FIGS. 8a and 8b are perspective views of downhole tool 100. In FIG. 8a, retainer 118a is positioned so that inserts 117a and 117b extend through insert openings 119a and 119b, respectively. Further, retainer 118b is positioned so that inserts 117c and 117d extend through insert openings 119c and 119d, respectively. As discussed in more detail above, insert openings 119a, 119b, 119c and 119d are sized and shaped to receive inserts 117a, 117b, 117c and 117d, respectively, as shown in FIG. 8b.

In FIG. 8b, inserts 117a and 117b are held to corresponding fastener heads 120a and 120b, as well as to journal 113a, by retainer 118a. In FIG. 8b, retainer 118a engages inserts 117a and 117b, and inserts 117a and 117b engage fastener heads 120a and 120b, respectively. Further, insert openings 119c and 119d are sized and shaped to receive inserts 117c and 117d, respectively, so that inserts 117c and 117d are held to corresponding fastener heads 120c and 120d, as well as to journal 113a, by retainer 118b. In FIG. 8b, retainer 118b engages inserts 117c and 117d, and inserts 117c and 117d engage fastener heads 120c and 120d, respectively.

FIG. 8c is a cut-away side view of downhole tool 100 taken along a cut-line 8c-8c of FIG. 8b. In this embodiment, inserts 117a and 117b are flush with retainer 118a (FIG. 8c), and inserts 117c and 117d are flush with retainer 118b. However, in other embodiments, inserts 117a and 117b extend below retainer 118a, and inserts 117c and 117d extend below retainer 118b. Inserts 117a and 117b extend below retainer 118a when inserts 117a and 117b terminate before an outer surface of retainer 118a, and inserts 117c and 117d extend below retainer 118b when inserts 117c and 117d terminate before an outer surface of retainer 118b.

Further, in some embodiments, inserts 117a and 117b extend above retainer 118a, and inserts 117c and 117d extend above retainer 118b. Inserts 117a and 117b extend above retainer 118a when inserts 117a and 117b terminate above an outer surface of retainer 118a, and inserts 117c and 117d extend above retainer 118b when inserts 117c and 117d terminate above an outer surface of retainer 118b.

In the embodiment of FIG. 8c, fastener heads 120a and 120b are flush with retainer 118a and inserts 117a and 117b, respectively, and fastener heads 120c and 120d are flush with retainer 118b and inserts 117c and 117d, respectively.

However, in other embodiments, fastener heads 120a and 120b extend below retainer 118a and inserts 117a and 117b, respectively, and fastener heads 120c and 120d extend below retainer 118b and inserts 117c and 117d, respectively. Fastener heads 120a and 120b extend below retainer 118a when fastener heads 120a and 120b terminate below an outer surface of retainer 118a, and fastener heads 120c and 120d extend below retainer 118b when fastener heads 120c and 120d terminate below an outer surface of retainer 118b.

In some embodiments, fastener heads 120a and 120b extend above retainer 118a and inserts 117a and 117b, respectively, and fastener heads 120c and 120d extend above retainer 118b and inserts 117c and 117d, respectively. Fastener heads 120a and 120b extend above retainer 118a when fastener heads 120a and 120b terminate above an outer surface of retainer 118a, and fastener heads 120c and 120d extend above retainer 118b when fastener heads 120c and 120d terminate above an outer surface of retainer 118b.

As mentioned above, inserts 117a and 117b engage fastener heads 120a and 120b, and retainer 118a engages inserts 117a and 117b to hold inserts 117a and 117b to fastener heads 120a and 120b, respectively. In operation, retainer 118a engages inserts 117a and 117b to restrict their ability to rotate relative to fastener heads 120a and 120b, respectively. Journal 113a is less likely to be uncoupled from downhole tool frames 101a and 101b when retainer 118a engages inserts 117a and 117b to restrict their ability to rotate relative to fastener heads 120a and 120b. In this way, fasteners 115a and 115b are less likely to undesirably loosen. Journal 113a is more likely to be uncoupled from downhole tool frames 101a and 101b when fasteners 115a and 115b undesirably loosen.

In FIG. 8c, inserts 117a and 117b are flush with retainer 118a, and fastener heads 120a and 120b are flush with retainer 118a and inserts 117a and 117b, respectively, so that fastener heads 120a and 120b are less likely to be damaged. For example, inserts 117a and 117b are flush with retainer 118a, and fastener heads 120a and 120b are flush with retainer 118a and inserts 117a and 117b, respectively, so that fastener heads 120a and 120b are less likely to be damaged by being sheared-off. Journal 113a is more likely to be uncoupled from downhole tool frames 101a and 101b in response to fastener heads 120a and 120b being sheared-off. Further, journal 113a is less likely to be uncoupled from downhole tool frames 101a and 101b in response to fastener heads 120a and 120b being sheared off. Hence, retainer 118a and inserts 117a and 117b reduce the likelihood that fasteners 115a and 115b will be damaged in response to the extreme loads that downhole tool 100 experiences when boring through the formation.

As mentioned above, inserts 117c and 117d engage fastener heads 120c and 120d, and retainer 118b engages inserts 117c and 117d to hold inserts 117c and 117d to fastener heads 120c and 120d, respectively. In operation, retainer 118b engages inserts 117c and 117d to restrict their ability to rotate relative to fastener heads 120c and 120d, respectively. Journal 113a is less likely to be uncoupled from downhole tool frames 101a and 101b when retainer 118b engages inserts 117c and 117d to restrict their ability to rotate relative to fastener heads 120c and 120d. In this way, fasteners 115c and 115d are less likely to undesirably loosen. Journal 113a is more likely to be uncoupled from downhole tool frames 101a and 101b when fasteners 115c and 115d undesirably loosen.

In FIG. 8c, inserts 117c and 117d are flush with retainer 118b, and fastener heads 120c and 120d are flush with retainer 118b and inserts 117c and 117d, respectively, so that fastener heads 120c and 120d are less likely to be damaged. For example, inserts 117c and 117d are flush with retainer 118b, and fastener heads 120c and 120d are flush with retainer 118b and inserts 117c and 117d, respectively, so that fastener heads 120c and 120d are less likely to be damaged by being sheared-off. Journal 113a is more likely to be uncoupled from downhole tool frames 101a and 101b in response to fastener heads 120c and 120d being sheared-off. Further, journal 113a is less likely to be uncoupled from downhole tool frames 101c and 101d in response to fastener heads 120c and 120d being sheared off. Hence, retainer 118b and inserts 117c and 117d reduce the likelihood that fasteners 115c and 115d will be damaged in response to the extreme loads that downhole tool 100 experiences when boring through the formation. It should be noted that, in some embodiments, the retainers and inserts of cutter assembly 110a can be welded to downhole tool frames 101a and 101b, as will be discussed in more detail with FIG. 8j.

FIGS. 8d and 8e are cut-away side view of insert 117a and retainer 118a, respectively, taken along cut-line 8c-8c of FIG. 8b. In this embodiment, insert 117a includes a tapered portion 125a which extends outwardly from its outer periphery and away from fastener head openings 121a. Further, retainer 118a includes a tapered portion 126a which extends outwardly from insert openings 119a. Tapered portions 125a and 125b are sized and shaped to match each other, as shown in FIG. 8c. Tapered portions 125a and 125b restrict the ability of insert 117a so move through fastener head openings 121a so that retainer 118a holds insert 117a more securely to journal 113a. In this way, insert 117a and retainer 118a include matching tapered portions.

FIG. 8f is a cut-away side view of downhole tool 100 FIGS. 8a and 8b taken along cut-line 8c-8c of FIG. 8b, wherein fasteners 115a and 115a terminate below inserts 117a and 117b and retainer 118a. Fastener 115a terminates below insert 117a and retainer 118a because fastener head 120a terminates below insert 117a and retainer 118a. In this way, fastener 115a includes a fastener head which terminates below at least one of an insert and retainer. Fastener 115b terminates below insert 117b and retainer 118a. In this way, fastener 115b includes a fastener head which terminates below at least one of an insert and retainer.

FIG. 8g is a cut-away side view of downhole tool 100 FIGS. 8a and 8b taken along cut-line 8c-8c of FIG. 8b, wherein fasteners 115a and 115b terminate above inserts 117a and 117b and retainer 118a. Fastener 115a terminates above insert 117a and retainer 118a because fastener head 120a terminates above insert 117a and retainer 118a. In this way, fastener 115a includes a fastener head which terminates above at least one of an insert and retainer. Fastener 115b terminates above insert 117b and retainer 118a. In this way, fastener 115b includes a fastener head which terminates above at least one of an insert and retainer.

FIG. 8h is a cut-away side view of downhole tool 100 FIGS. 8a and 8b taken along cut-line 8c-8c of FIG. 8b, wherein fasteners 120a and 120b and inserts 117a and 117b terminate below retainer 118a. Fastener 115a terminates below retainer 118a because fastener head 120a terminates below retainer 118a. In this way, fastener 115a includes a fastener head which terminates below a retainer. Fastener 115b terminates below retainer 118a. In this way, fastener 115b includes a fastener head which terminates below a retainer. It should be noted that, in this embodiment, fastener heads 120a and 120b are flush with inserts 117a and 117b, respectively. Further, fastener heads 120a and 120b are not flush with retainer 118a.

FIG. 8i is a cut-away side view of downhole tool 100 FIGS. 8a and 8b taken along cut-line 8c-8c of FIG. 8b, wherein fasteners 120a and 120b and inserts 117a and 117b terminate above retainer 118a. Fastener 115a terminates above retainer 118a because fastener head 120a terminates above retainer 118a. In this way, fastener 115a includes a fastener head which terminates above a retainer. Fastener 115b terminates above retainer 118a. In this way, fastener 115b includes a fastener head which terminates above a retainer. It should be noted that, in this embodiment, fastener heads 120a and 120b are flush with inserts 117a and 117b, respectively. Further, fastener heads 120a and 120b are not flush with retainer 118a.

Hence, FIGS. 8f, 8g, 8h and 8i illustrate that tool 100 can include a fastener which includes a fastener head which terminates above at least one of an insert and retainer. Further, FIGS. 8f, 8g, 8h and 8i illustrate that tool 100 can include a fastener which includes a fastener head which terminates below at least one of an insert and retainer.

FIG. 8j is a close-up perspective view of downhole tool 100. In this embodiment, downhole tool 100 includes a weldment 122a extending between retainer 118a and downhole tool frame 101b, and a weldment 122b extending between retainer 118b and downhole tool frame 101a. Weldment 122a holds retainer 118a to downhole tool frame 101a and reduces the likelihood that it will be decoupled therefrom. Further, weldment 122b holds retainer 118b to downhole tool frame 101b and reduces the likelihood that it will be decoupled therefrom. It should be noted that downhole tool 100 typically includes weldments positioned on the opposed side of retainers 118a and 118b, and extend between retainers 118a and 118b and downhole tool frames 101a and 101b. However, these weldments are not shown in the view of FIG. 8j.

In this embodiment, downhole tool 100 includes weldments 123a and 123b which extend between retainer 118a and inserts 117a and 117b, respectively. Weldments 123a and 123b hold inserts 117a and 117b to retainer 118a to reduce the likelihood that they will become loose.

In this embodiment, downhole tool 100 includes weldments 123c and 123d which extend between retainer 118b and inserts 117c and 117d, respectively. Weldments 123c and 123d hold inserts 117c and 117d and fastener heads 120c and 120d to retainer 118b to reduce the likelihood that they will undesirably loosen.

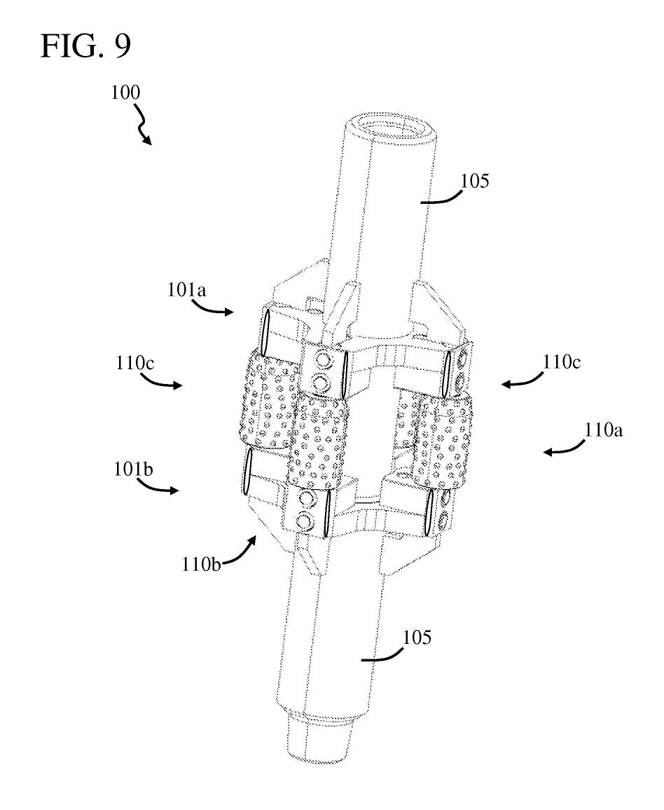

FIG. 9 is a perspective view of downhole tool 100 of FIG. 8d being carried by a drill string 105. In this embodiment, downhole tool 100 includes cutter assemblies 110a, 110b, 110c and 110d, wherein cutter assemblies 110b, 110c and 110d are the same as cutter assembly 110a. Drill string 105 extends through downhole tool frames 101a and 101b, and cutter assemblies 110b, 110c and 110d are spaced apart from each other around drill string 105.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A downhole tool, comprising:
a journal fastened to a downhole tool frame with a fastener;
an insert engaged with the fastener; and
a retainer engaged with the downhole tool frame and insert.

2. The tool of claim 1, further including a weldment which holds the retainer to the downhole tool frame.

3. The tool of claim 1, further including a weldment which holds the insert to the fastener.

4. The tool of claim 1, further including a weldment which holds the fastener to the insert and retainer.

5. The tool of claim 1, wherein the insert and retainer restrict the ability of the fastener to rotate.

6. The tool of claim 1, wherein the fastener includes a fastener head which is flush with the insert and retainer.

7. The tool of claim 1, wherein the insert and retainer include matching tapered portions.

8. The tool of claim 1, wherein the fastener includes a fastener head which terminates above at least one of the insert and retainer.

9. The tool of claim 1, wherein the fastener includes a fastener head which terminates below at least one of the insert and retainer.

10. A locking fastener assembly, comprising:
a retainer with a first retainer opening extending therethrough;
a first insert with a first central hexagonal opening; and
a first fastener which includes a first hexagonal fastener head sized and shaped to be received by the first central hexagonal opening.

11. The assembly of claim 10, wherein the retainer and first insert include first and second tapered portions, respectively, sized and shaped to match each other.

12. The assembly of claim 10, wherein the retainer further includes a second retainer opening.

13. The assembly of claim 12, further including a second insert with a second central hexagonal opening, and a second fastener which includes a second hexagonal fastener head sized and shaped to be received by the second central hexagonal opening.

14. The assembly of claim 13, wherein the retainer and second insert include third and fourth tapered portions, respectively, sized and shaped to match each other.

15. A method, comprising:
fastening a journal to a downhole tool frame with a fastener;
engaging an insert with the fastener; and
engaging a retainer with the downhole tool frame and insert.

16. The method of claim 15, further including providing a weldment which holds the retainer to the downhole tool frame.

17. The method of claim 15, further including providing a weldment which holds the insert to the fastener.

18. The method of claim 15, further including providing a weldment which holds the fastener to the insert and retainer.

19. The method of claim 15, wherein the insert and retainer restrict the ability of the fastener to rotate.

20. The method of claim 15, wherein the fastener includes a fastener head which is flush with the insert and retainer.

21. The method of claim 15, wherein the insert and retainer include matching tapered portions.

22. The method of claim 15, wherein the retainer is engaged with a reamer surface of the downhole tool frame.
